(19) United States
(12) Patent Application Publication
(10) Pub. No.: US 2026/0203330 A1
(43) Pub. Date: Jul. 16, 2026

(54) System and Method for Delivering Multi-Source Content and Contextual Affiliate Links by a Conversational Interface to be embedded in a Creator Network

(71) Applicant: iSonic Inc, Palo Alto, CA (US)

(72) Inventors: Ankesh Kumar, Palo Alto, CA (US); Torlach Rush, Dublin (IE); Praneel Panchigar, Chicago, IL (US)

(73) Assignee: iSonic Inc., Palo Alto, CA (US)

(21) Appl. No.: 19/431,173

(22) Filed: Dec. 23, 2025

Related U.S. Application Data
(60) Provisional application No. 63/745,655, filed on Jan. 15, 2025.

(51) Int. Cl. G06F 16/334; G06F 16/38

(52) U.S. Cl. CPC G06F 16/3347; G06F 16/38

(57) ABSTRACT

Techniques relating to delivering multi-source content and contextual affiliate links are disclosed. A method for delivering multi-source content and contextual affiliate links by a conversational interface may include ingesting content associated with a content creator, normalizing and/or transforming the content, tagging the content with metadata, thereby generating enriched content, generating a vector representation of the content, storing the enriched content and the vector representation of the content in a vector database, performing content matching between a user query received by a conversational user interface, and outputting a response to the user query comprising multi-source content. A system for delivering multi-source content and contextual affiliate links may include a conversational user interface, a content ingestion engine, a metadata tagging module configured to generate enriched content, an embedding module configured to generate a vector representation of the enriched content, a vector database, a content matching module, and an NLP layer.

### CROSS-REFERENCE TO RELATED APPLICATIONS

This application claims the benefit of U.S. Provisional Patent Application No. 63/745,655 entitled “AI-Driven Content Integration and Affiliate Link Optimization System with Contextual Query Responses and Consumer Insight Generation,” filed Jan. 15, 2025, the contents of which are hereby incorporated by reference in their entirety.

### BACKGROUND OF INVENTION

Content creators generate a large volume of valuable content across various platforms, including social media, direct messaging, blogs, videos, and podcasts. However, their audience often struggles to locate relevant content due to fragmentation across platforms. Additionally, creators face limitations in monetizing this engagement beyond a platform's built-in options.

While AI chat systems exist for content ingestion from primary sources, none currently combine multiple linked content sources, including social media platforms, analyze them based on relevance, and rank them by user-defined criteria. Existing solutions also fail to blend the unique tones and sentiments from reviews, affiliate content, and social media to offer personalized, insightful responses. Current solutions fail to provide a unified, intelligent, and monetizable conversational interface that enables creators and their audience real-time access to a creator's distributed content.

Therefore, delivering multi-source content and contextual affiliate links using a conversational interface embedded in a creator's network is desirable.

### BRIEF SUMMARY

A system and method are disclosed for delivering multi-source content and contextual affiliate links by a conversational interface. A method for delivering multi-source content and contextual affiliate links by a conversational interface may include: ingesting content from a plurality of content sources associated with a content creator; normalizing and/or transforming, by an natural language processing (NLP) layer, the content; tagging the content with metadata, thereby generating enriched content; generating a vector representation of the content, including embedding the metadata; storing the enriched content and the vector representation of the content in a vector database; performing content matching between a user query received by a conversational user interface against the vector database; and outputting a response to the user query comprising multi-source content. In some examples, generating the vector representation comprises semantic embedding. In some examples, performing content matching comprises NLP enrichment and performing a hybrid smart vector search. In some examples, performing content matching comprises aligning user query semantics, content response semantics, and affiliate product metadata. In some examples, the content is sourced from a plurality of content sources, including one, or a combination, of a primary content creator website, a linked affiliate page, an affiliate page review, a social media post, a creator-affiliated blog, a creator-affiliated video, a creator-affiliated audio, and a direct message. In some examples, the response further comprises retrieved links. In some examples, the response comprises an auto-generated response. In some examples, the response comprises a manual response from the content creator. In some examples, the method also includes determining a content depth score for each content source based on relevance, sentiment, and relationship strength with a primary content creator site.

A system for delivering multi-source content and contextual affiliate links by a conversational interface may include: a memory comprising non-transitory computer-readable storage medium configured to store content and metadata; a vector database; one or more processors configured to execute instructions stored on the non-transitory computer-readable storage medium to: ingest content associated with a content creator, normalize and/or transform, by a natural language processing layer, the content, tag the content with metadata, thereby generating enriched content, generate a vector representation of the content, including embedding the metadata, store the enriched content and the vector representation of the content in the vector database, perform content matching between a user query received by a conversational user interface against the vector database, and output a response to the user query comprising multi-source content.

Another system for delivering multi-source content and contextual affiliate links by a conversational interface may include: a conversational user interface by which a user query may be received and a response to the user query provided; a content ingestion engine configured to ingest content from a plurality of content sources associated with a content creator; an NLP layer configured to normalize and transform the content and a user query, such that various processes performed by the system operate on linguistically normalized data; a metadata tagging module configured to generate enriched content; an embedding module configured to generate a vector representation of the enriched content; a vector database storing indexed content, including the enriched content and the vector representation; and a content matching module configured to match the user query against indexed content from the vector database. In some examples, the content matching module is configured to perform semantic understanding, keyword extraction, and topic matching against the indexed content. In some examples, the system also includes a large language model configured to generate a response comprising multi-source content based matches from the indexed content. In some examples, the response further comprises retrieved links. In some examples, the response includes an auto-generated response. In some examples, the response includes a manual response from the content creator. In some examples, the content ingestion engine comprises a direct messages ingestion engine and a comments ingestion engine.

### BRIEF DESCRIPTION OF THE DRAWINGS

Various non-limiting and non-exhaustive aspects and features of the present disclosure are described hereinbelow with references to the drawings, wherein:

FIG. 1 is a simplified block diagram illustrating a system for delivering a response comprising multi-source content and contextual affiliate links by a conversational interface to be embedded in a creator network, in accordance with one or more embodiments.

FIG. 2 is a flow diagram illustrating an exemplary content matching workflow, in accordance with one or more embodiments.

FIG. 3 is a flow diagram illustrating an exemplary hyperlink embedding and management workflow, in accordance with one or more embodiments.

FIG. 4 is a flow diagram illustrating a message handling and monetization workflow, in accordance with one or more embodiments.

FIG. 5 is a flow diagram illustrating a method for delivering a response comprising multi-source content and contextual affiliate links by a conversational interface to be embedded in a creator network, in accordance with one or more embodiments.

FIG. 6A is a simplified block diagram of an exemplary computing system configured to implement the system shown in FIG. 1 and to perform steps of the method illustrated in FIG. 2, in accordance with one or more embodiments.

FIG. 6B is a simplified block diagram of an exemplary distributed computing system implemented by a plurality of the computing devices, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to delivering multi-source content and contextual affiliate links by a conversational interface to be embedded in a creator network. A system for delivering multi-source content and contextual affiliate links by a conversational interface may comprise an artificial intelligence (AI) chat system configured to receive a user prompt and deliver a response containing multi-source content and contextual affiliate links. An AI chat system may be configured to ingest content from a plurality of content sources (e.g., multiple online data sources) affiliated with a content creator, process the content data (e.g., index content data for relevance and accessibility), unify the content data into a single conversational layer, and deliver relevant responses (e.g., excerpts, links, automatic and manual responses, etc.) from the content sources and/or the content creator in a chat (i.e., conversational) user interface (i.e., UI/UX) in response to a user prompt (i.e., query). Some or all of the plurality of content sources, along with the chat user interface, may comprise a creator network. When a user submits a query via a conversational interface, the system dynamically generates a natural language response with relevant excerpts from the indexed content and, optionally, appends hyperlinks that match the context provided by the query, as well as provides other auto-generated and manual outputs. This method allows creators to scale audience interaction and engagement, to manage and monetize conversations across multiple channels with minimal manual effort. A unique aspect of the system is its ability to redirect and handle direct messages, emails, and comments typically sent to content creators. These incoming messages, which are often repetitive or burdensome, may instead be routed to an AI chat agent. The agent may be configured to respond to questions using the creator's existing content, and may include in the response contextually relevant hyperlinks, transforming high message volumes from a distraction into a time saving and revenue generating opportunity. This approach to responding to comments differs from direct messages and email responses. With respect to comments, the system may aggregate, summarize, and categorize responses before strategically inserting system responses into a response graph (i.e., a logical representation of the decision space used to determine how and where to respond to a user interaction) of the creator's post. In some examples, the response graph (i.e., response decision graph) may capture the relationship among three elements: (1) enriched features of a commenter's message, including semantic intent, sentiment, metadata, and contextual signals; (2) contextual attributes of a creator's underlying post; and (3) a set of possible response actions available to the system (i.e., AI chat system, as described herein). In some examples, possible response actions include responding directly in-thread, posting a new top-level creator comment, sending a direct message to the user, and choosing not to respond (i.e., ignore). A response graph may represent the evaluated set of response pathways and classification outputs that guide which pathway is selected. It also may reflect the outcome of the comment-to-direct message workflow described below, high-value scoring, confidence scoring, and strategies defined by a creator.

The AI chat system may be configured to pull data from a plurality of content sources, including one or a combination of the following:
a primary content creator site: a main website where the AI chat is being hosted;
one or more linked affiliate pages: external affiliate sites linked by the primary content creator site;
one or more affiliate page reviews: user reviews from linked affiliate pages, providing additional contextual user insights (i.e., information that provides additional situational, behavioral, or preference-related signals that can improve response relevance, ranking, or link selection);
one or more social platform APIs (e.g., Instagram®, Tik Tok®, LinkedIn®, etc.): content including posts, captions, comments, and short videos, analyzed for relevance and sentiment to enhance responses;
blogs and RSS feeds;
video content platforms (e.g., YouTube®, Vimeo®, etc.);
document repositories: may contain documents in varying formats (e.g., PDFs, PPTs, Docs, etc.); and
direct messages (dms);
   among other content sources. In some examples, the contextual user insights may arise from one or both of the following categories of data: (1) insights relating to a content creator, and (2) insights relating to a content creator's audience. Insights relating to a content creator may include signals about the creator that are obtained from external public sources beyond what the creator directly provides to the AI chat system. Examples include publicly available content published by the creator on other platforms, interviews, product pages, or reviews that mention the creator. These insights can help refine how the system matches user queries to the creator's body of work or areas of expertise. Insights relating to the content creator's audience may include signals derived from data associated with users who interact with the creator or with linked affiliate pages. For example, if a follower has left a review on an affiliate product page that is tied to one of the creator's recommendations, this review may provide contextual insight into the user's interests, sentiment, product experience, or familiarity with the creator's content. These insights help the system better evaluate user intent and determine what type of response, content excerpt, or hyperlink would be most relevant. Both categories support the system's broader objective of producing responses that reflect an informed understanding of the creator's profile and the audience's behavior when such signals are available and legally permissible to use.

The AI chat system may determine a content depth score to each content source based on relevance, sentiment (e.g., emotional tone of the content, such as whether it is positive, negative, or neutral, for example, using a natural language processing (NLP) technique), and relationship strength with the primary content creator site. Social platform content may be scored based on factors such as engagement metrics (e.g., likes, comments, shares) and contextual relevance of hashtags or captions to a query. In some examples, the AI chat system may assign a content depth score to each content source based on relevance, sentiment, and relationship strength with the primary content creator site. In some examples, a content depth score may include a relevancy score computed as a non-linear weighted combination of multiple signals derived from a user query and from enriched features (e.g., enriched content and other enrichment as described herein) generated during preprocessing (e.g., by metadata tagging, embedding, other NLP enrichment processes, as described herein). In some examples, core similarity may be calculated using vector-based semantic search, where embeddings of the query and content are compared using a distance metric (e.g., cosine similarity). Additional weighting factors may be incorporated, such as:
Temporal recency (e.g., favoring newer posts, messages, and links);
Engagement-derived scores and custom analytics scores (e.g., likes, shares, open rates);
Content modality/type (e.g., distinguishing between video transcripts, social posts, long-form articles, or hyperlinks);
Metadata relevance (e.g., presence of hyperlinks, referenced product IDs, platform context);
Query transformations (e.g., synonym expansion, keyword extraction, and intent classification) enrich the input and influence feature weights, enabling hybrid search that blends dense semantic similarity with sparse keyword matches.
   An overall score (e.g., content depth score) may be generated by applying biases, scaling factors, and learned weights, yielding a dynamic ranking function that adapts to a content creator's context. Weights may be optimized as a result of these inputs being part of a feedback loop system that adjusts weights to boost the content depth score.

For dynamic user-specific content summarization, AI-driven summaries may be dynamically tailored to user preferences, search history, and behavior patterns. For example, a user interested in visual content may receive responses incorporating relevant social media visual content alongside text summaries. For review sentiment fusion with core and social content, the AI chat system may be configured to combine sentiments from reviews and social media feedback to adapt a tone of a response. For example, a product with strong positive feedback on a social media platform may generate more visually-driven and enthusiastic responses. For social media signal integration, the AI chat system may be configured to incorporate real-time contextual social signals (e.g., trending hashtags, popular Tik Tok® challenges, Instagram® carousel insights, and the like) to enrich responses. The system may remain contextually updated with current trends for improved relevance and engagement, for example, through publicly observable trends and indicators that appear on major social media platforms. In some examples, these signals may originate from publicly available, platform-wide information such as trending hashtags, popular challenges, widely shared posts, and other real-time engagement trends on platforms like Instagram and TikTok. These signals may be incorporated by the system when they are publicly accessible or when they are made available to the creator under the relevant platform terms. In addition to these public trends, the system may also incorporate insights derived from the content creator's own connected social media accounts. For consumer insight generation, the AI chat system may be configured to aggregate responses from multiple sources, including social platforms, to generate insights on user sentiment trends, influencer engagement, and product appeal across platforms. In some examples, these context signals may be used within the AI chat system to enhance link selection or improve chat responses.

In addition, these insights also may support creator-facing analytics and consumer insight generation. Content creators can refine offerings or marketing strategies based on these insights. For example, these insights may be made available to a creator when the creator enrolls with the AI chat system. A creator may be authorized access under the appropriate permissions. Examples include analytics associated with the creator's posts, audience interactions, or content performance metrics that the platform provides to the creator. These information sources form the basis of the contextual social signals that an AI chat system service may provide to creators. The primary purpose of these insights is to help creators refine their offerings, marketing strategies, and audience engagement practices by understanding what is trending both broadly across social platforms and within their own follower communities. These insights may be produced by the AI chat system as part of analytics and service tools offered to creators when they sign up with the service.

In some examples, a large language model (LLM) may be used, along with a retrieval-augmented generation (RAG) pipeline, to generate a natural language response. The LLM may include a general-purpose natural language model configured to summarize, rephrase, and synthesize content. A RAG pipeline may be configured to integrate retrieval mechanisms (e.g., vector search, keyword filters, and metadata rules) with generation mechanisms (e.g., LLMs). Thereby the RAG pipeline may help generate summaries that are both contextually relevant and grounded in retrieved creator content. In some examples, auxiliary query enrichment modules (e.g., natural language understanding engines for classification, entity recognition, and intent detection) may further enhance the precision of a generated response. In some examples, the RAG pipeline may perform semantic matching of query embeddings against unified content embeddings, as well as contextualized retrieval based on intent and user session history.

Using the system and workflows described herein, an AI chat system may receive a user query from a user (e.g., a creator's audience) through various channels (e.g., a direct message, an e-mail message, a comment on a post or video, and the like). The AI chat system may preprocess and enrich the user query, including:
Text extraction and normalization;
Semantic embedding, including generating a vector representation of the query;
Query expansion, including adding synonyms, inferred intent, and extracted product and entity metadata;
Contextual tagging, including associating with time, platform, content type, and other associated metadata.
   The enriched query may then be matched against a centralized index (e.g., vector database, as described herein) that unifies:
Relational databases (structured data: creator information, products, affiliate metadata);
Vector databases (unstructured embeddings of transcripts, posts, messages);
Non-relational databases (JSON docs, logs, and semi-structured records).

A retrieval pipeline, as described herein, may then match and rank documents, posts, and affiliate links most relevant to the user query. Outputs may include a natural language response, generated by an LLM conditioned on retrieved items, along with embedded hyperlinks to posts, products, affiliate pages, and the like, surfaced alongside the natural language response. As such a contextualized, conversational answer that reflects the content creator's centralized knowledge base and business priorities may be provided.

In some examples, the AI chat system can dynamically surface tailored, personalized responses by integrating data from affiliate links, reviews, and social platforms, ensuring a multi-dimensional and highly relevant response. Use cases for an AI chat system, as described herein, include:
E-commerce: enhanced product recommendations using affiliate links, reviews, and influencer content;
Travel and lifestyle content: leveraging visual content and hashtags to engage users with rich media recommendations;
Affiliate marketing: increasing conversions by aligning responses with trends and user sentiment across platforms.

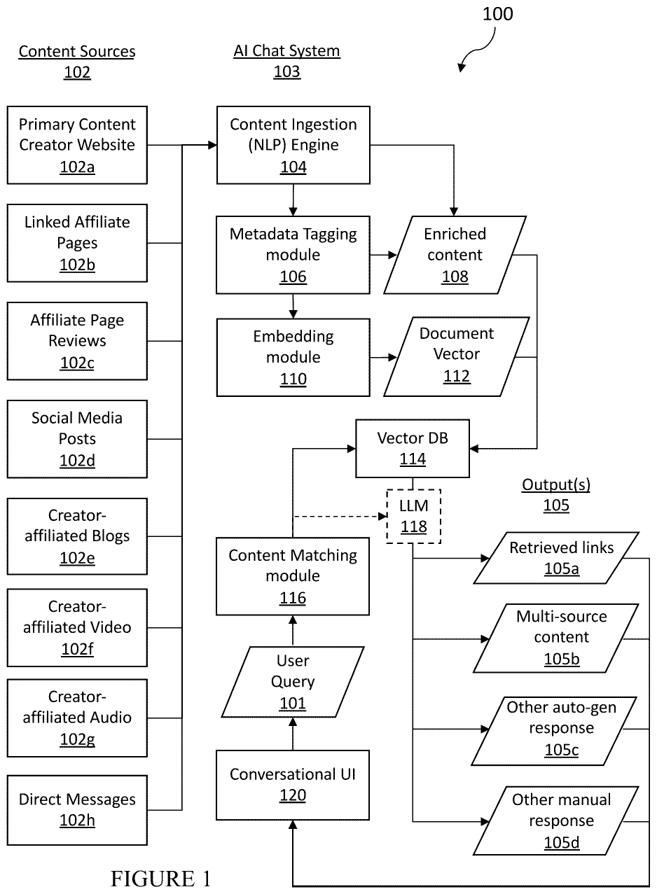

FIG. 1 is a simplified block diagram illustrating a system for delivering a response comprising multi-source content and contextual affiliate links by a conversational interface to be embedded in a creator network, in accordance with one or more embodiments. Some or all of the components shown in diagram 100 may comprise a creator network. Diagram 100 shows an artificial intelligence (AI) chat system 103 configured to ingest content from content sources 102 associated with a content creator, process the ingested content into enriched content 108 and/or document vector 112 (i.e., vector representations), which may be stored in vector database 114, and from which content may be matched with a query 101 to output retrieved links and multi-source content 118 associated with the content creator. In some examples, content sources 102 may comprise one, or a combination, of a plurality of content sources, including without limitation, primary content creator website 102a, linked affiliate pages 102b, affiliate page reviews 102c, social media posts 102d, creator-affiliated blogs 102e, creator-affiliated video 102f (e.g., in various video formats and lengths across various websites and online platforms), creator-affiliated audio 102g (e.g., podcasts), and direct messages 102h, among others. AI chat system 103 may comprise content ingestion (NLP) engine 104, metadata tagging module 106, embedding module 110, vector database 114, and content matching module 116, among other components. In some examples, NLP engine 104 may be configured to process content from one, or a combination, of content sources 102. In some examples, NLP engine 104 may be configured to perform chunking, normalization, transformation, and other processes, on the ingested content to ensure that it is searchable and context-ready. In some examples, NLP engine 104 (and other NLP engines described herein) may be implemented as a general-purpose NLP layer providing linguistic and structural groundwork for ingestion, retrieval, and generation to ensure that each of these stages operates on linguistically normalized data. Metadata tagging module 106 may be configured to generate metadata associated with the ingested content (e.g., including tagging or generating tags) to generate enriched content 108. In some examples, tags and other metadata also may be provided to embedding module 110 to be embedded, thereby generating document vector 112 (i.e., a vector representation of enriched content 108). In some examples, enriched content 108 and document vector 112 may be stored and/or organized (i.e., indexed) into vector database 114. In some examples, vector database 114 may be used to provide an output 105. In some examples, a content matching module 116 may be configured to perform a content matching process that takes user query 101 and performs semantic understanding, keyword extraction, and topic matching against indexed content from vector database 114 in order to generate one, or a combination, of outputs 105. In some examples, output(s) 105 may comprise retrieved links 105a, multi-source content 105b, other auto-generated response 105c, and other manual response 105d (e.g., creator-provided manual response). In some examples, user query 101 may be received by a conversational user interface (UI) 120. In some examples, conversational UI 120 may comprise a user-friendly, conversational interface (e.g., text/chat UI) enabling contextual memory to handle follow-up questions. In some examples, conversational UI 120 may implement intent recognition and question classification (e.g., transactional, informational, etc.). In some examples, conversational UI 120 may perform query embedding and intent detection, converting natural language queries into embeddings and classifying user intent using NLP classifiers.

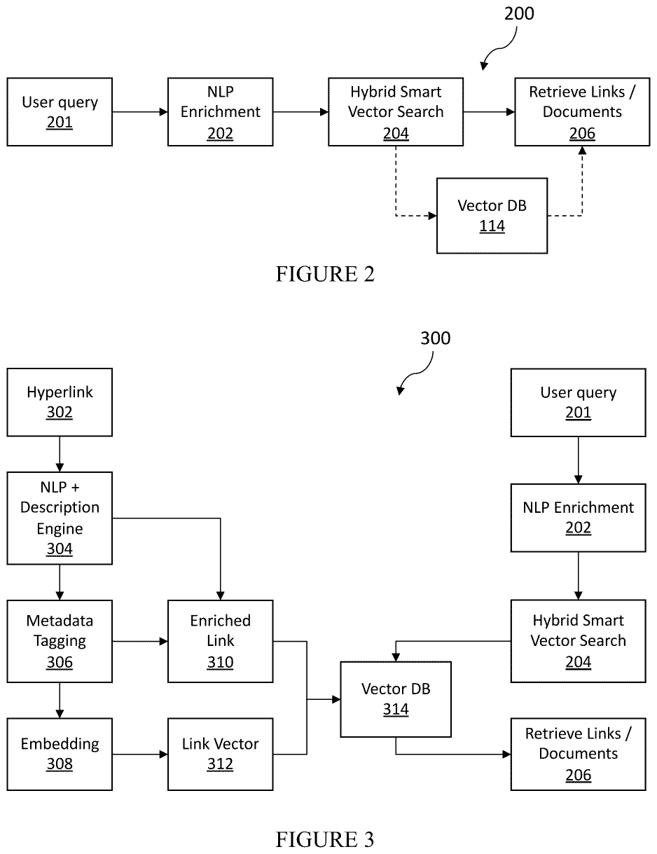

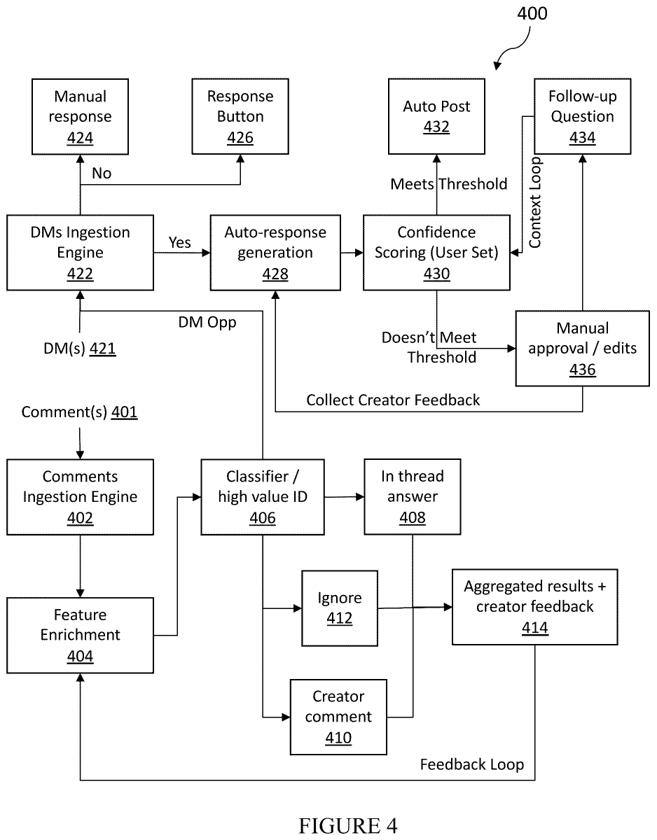

More details about the content matching process are described below and shown in FIG. 2. More details about the various outputs and responses are described below and shown in FIG. 4 (e.g., message handling and monetization workflow). In some examples, a large language model (LLM) 126 may generate and format the final output(s) 105 for providing a response to the user. In some examples, LLM 126 may further be configured to maintain source transparency (e.g., citations). In some examples, LLM 126 may be configured to generate conversational responses where tone and style are personalized and appropriate to user intent.

### Example Methods

FIG. 2 is a flow diagram illustrating an exemplary content matching workflow, in accordance with one or more embodiments. In some examples, workflow 200 may be implemented by elements of AI chat system 103 shows a user query 201 undergoing NLP enrichment 202 (e.g., by NLP engine 104 or other NLP layer, as described herein). NLP enrichment 202 may comprise extracting keywords and topics. In some examples, a hybrid smart vector search 204 may be performed to match the extracted keywords and topics against indexed content (e.g., in vector database 114) and relevant matches may be ranked. Associated links and documents may be retrieved at 206 (e.g., from vector database 114). In some examples, a natural language response formatted (e.g., by LLM 118) to provide to the user in response to their user query 201, for example, in a chat (i.e., conversational) user interface. The natural language response may comprise links and documents retrieved at 206.

In some examples, hybrid smart vector search 204 may include a ranking algorithm, wherein a hybrid of semantic similarity, temporal recency, and engagement-based weighting to rank candidate responses. In some examples, the ranking algorithm also informs link embedding decisions (e.g., scoring hyperlink relevance for insertion into responses), feedback loops (e.g., ranking weights are adjusted based on creator feedback and audience engagement), and opportunity prioritization (e.g., to determine which comments or messages represent high-value interaction prospects). In some examples, the ranking algorithm may provide a unified scoring framework across multiple decision layers of the system.

In other examples, a dynamic query-content-affiliate matching layer may be implemented to dynamically align a plurality of dimensions, including user query semantics, content response semantics, and affiliate product metadata. User query semantics (e. g, by a conversational UI) may extract user intent (e.g., recommendations requests) through semantic embeddings, and also may categorize intent type (e.g., informational vs. transactional). Content response semantics may analyze retrieved creator-generated content using NLP and transformer embeddings to identify relevant product mentions or opportunities for affiliate placement. Content response semantics also may score potential affiliate insertions based on semantic proximity to user intent and query specifics. Affiliate product metadata may include product category with detailed attributes (e.g., brand, price, type), historical conversion and performance metrics, and current promotional status (e.g., active discounts). In some examples, a real-time semantic scoring algorithm may be employed to score affiliate products dynamically against the intersection of query intent embeddings, content response embeddings, and affiliate metadata embeddings. Real-time semantic scoring may employ vector similarity along with weighted metadata scoring to rank affiliates in real time.

FIG. 3 is a flow diagram illustrating an exemplary hyperlink embedding and management workflow, in accordance with one or more embodiments. In diagram 300, a hyperlink 302 may be processed by an NLP+description engine 304 configured to perform text extraction and normalization (e.g., OCR for PDFs and images, speech-to-text transcription for videos, spell-check, sentence segmentation, formatting, and other text normalization). Metadata tagging 306 may function similarly to other metadata tagging as described herein to generate an enriched link 310. Embedding 308 may function similarly to other embedding described herein to generate link vector 312 (e.g., a vector representation of enriched link 310). Enriched link 310 and link vector 312 may be stored and indexed in vector database 314 to be retrieved, for example, when content matching is being performed and a response is being generated (e.g., retrieve links/documents 206).

FIG. 4 is a flow diagram illustrating a message handling and monetization workflow, in accordance with one or more embodiments. In diagram 400, inbound messages (e.g., direct messages, emails, comments, and other user queries) are redirected to an AI chat agent (e.g., AI chat system 103). The AI chat agent may generate a relevant response based on previously indexed content and may append contextual hyperlinks to the response. The response may be delivered to the user that originated the inbound message, and interaction data may be tracked for performance optimization. In particular, a comment 401 may be ingested by comments ingestion engine 402 and feature enrichment 404 performed on the ingested comment. In some examples, comments ingestion engine may perform normalization and transformation (including sanitization and safety checks) on a comment 401, which may drive feature enrichment 404 and classifier/high value ID 406. In some examples, feature enrichment 404 may augment each comment with contextual and user-level signals so the system can interpret implied context. Feature enrichment 404 may further link the comment to (i) an underlying post and what's being promoted, (ii) a creator (poster), and (iii) a commenter. In some examples, enrichment may draw on available first-party or platform-authorized data (e.g., Meta), as well as imputed attributes, such as posting time, probable location (time zone or text reference), and semantic intent derived from language understanding. The enriched content (e.g., ingested, enriched comment) may be provided to a classifier/high value identifier 406 configured to rank and classify response opportunities accurately and to identify high value opportunities (e.g., compute a high value score). The classifier/high value identifier 406 may determine whether to provide an in thread answer 408, a creator comment 410 (e.g., a fresh top-level comment by the creator under a post), or to ignore 412, based on a classification and the high value score. Aggregated results and creator feedback 414 may be provided back to feature enrichment 404 for improved feature enrichment. These enriched features help the system fingerprint or profile a commenter as a potential target audience for a creator's product or service. Classification results may be fed back through the classification loop and the high-value scoring, allowing the system to rank and classify opportunities more accurately while remaining privacy-aware.

In some examples, this classification loop may use creator feedback and system performance to update weights over time. For example, feedback may include thumbs up or down on a generated response, whether a creator edited a response before sending, and natural-language directives that express the creator's heuristics or strategy. Inputs may update model weights and thresholds for an opportunity class (e.g., DM, in-thread, new creator comment, ignore), high-value classification cut-offs or thresholds, confidence score thresholds. Weighting also may incorporate attributes of a commenter (e.g., as permitted by a platform API or safely inferred), ensuring personalization remains compliant and context-sensitive.

In some examples, a high value score may be determined by classifier/high value identifier 406 using a scored classification approach, for example:

High Value Score (HV)=(w1×Creator Strategy Score)+(w2×Sentiment Score)+(w3×Keyword Score)+(w4×Classification Loop Score)+(w5×Commenter Attributes Score)

wherein creator strategy score represents alignment with the creator-provided strategy or directives, sentiment score represents sentiment analysis of a comment, keyword score represents presence of high-value keywords or catchphrases, classification loop score represents adjustments from the classification feedback loop, and commenter attributes score represents meta-provided or privacy-compliant imputed attributes of the commenter.

In some examples, classifier/high value identifier 406 also may identify a direct message (DM) opportunity. A DM opportunity may be identified using some or all enriched features combined with a classifier—either a fine-tuned LLM or a lighter-weight classification model. The classifier may predict when a private follow-up (e.g., via DM) is optimal. In some examples, a keyword or catch-phrase may trigger (e.g., purchase intent or request for details) or further guide the decision. In some examples, thresholds may be configurable or pre-selected by a creator. Also, existing DMs from the same user (e.g., resolved by handle or platform ID) may be linked to a comment to maintain full conversation continuity.

In some examples, an identified DM opportunity from classifier/high value identifier 406 may be provided to DMs ingestion engine 422, which also may be configured to ingest other direct message(s) 421. DMs ingestion engine 422 may be configured to ingest and transform user messages, including performing sanitization, normalization, and safety checks. In some examples, DMs ingestion engine 422 may be configured to route each message through one of three paths, after determining whether an ingested DM (e.g., from DM(s) 421 or from a comment routed through classifier/high value ID 406) is suitable for auto response generation or not: manual response 424, manual generation 426 (e.g., button, trigger), or auto-response generation 428 (i.e., auto-generated response). In some examples, auto-generation of responses may be enabled by a creator and implemented where the ingested DM meets a confidence-score threshold, the confidence score being determined by confidence scoring module (user set) 430. If the confidence-score threshold is met, the auto-generated response (i.e., by auto-response generation 428) may auto post at 432. If the confidence-score threshold is not met, the auto-generated response may undergo manual approval and edits at 436.

In some examples, a confidence score (C) evaluates each AI-generated response before it is delivered using, for example, this formula:

C=(a1×Relevancy)+(a2×Context)+(a3×(1−Hallucination Risk))+(a4×User Setting)+(a5×AIMON Features)

wherein relevancy represents semantic alignment between a user query and a generated response, context represents appropriateness of a response to a surrounding conversation or post, hallucination risk represents inverse weighting from a hallucination-detection module (e.g., AIMon labs'HDM-1, HDM-2, etc.), user setting represents creator-defined preferences and thresholds, and AIMon features represents signals from an external hallucination-detection partner system that may verify factual grounding and retrieval alignment. In some examples, in addition to embedding hallucination risk mitigation into the confidence score, two layers, including synchronous guardrails and asynchronous guardrails, may operate to mitigate hallucination risk. Synchronous guardrails may be active at generation time, and may use retrieval grounding, citation presence, and AIMon checks to block or penalize unsupported outputs. Asynchronous guardrails may be implemented as post-generation audits using creator feedback and outcome analytics. Hallucination risk can contribute negatively to confidence, so persistent corrections by creators (e.g., creator feedback collected and fed back to auto-response generation 428) may reduce future confidence weighting of similar outputs, thus maintaining factual accuracy and trust without impeding conversational flow. In some examples, follow-up questions 434 also may be fed back to confidence scoring module 430.

Confidence scores above a user-defined threshold may trigger auto-posting, while confidence scores below said threshold may require manual review or editing. Creator feedback (e.g., positive or negative indication, such as a thumbs up or down, edit frequency, and the like) may continuously recalibrate weighting coefficients a1 through a5 in the above confidence score formula.

When identity resolution is possible on the same platform, existing DMs may be linked to comments from the user from which a query or comment is received. This platform-scoped linkage allows the AI chat agent to unify comment and DM histories, improving personalization, response quality, and opportunity detection. Privacy-preserving principles may be applied to all enrichment and imputation processes described herein. For example, system access may be limited to data available through authorized APIs or creator-owned datasets. Imputation (e.g., probable location) may use coarse, non-identifying indicators such as posting time or time zone differences and may be optional. The systems described herein may function fully without any personally identifiable data.

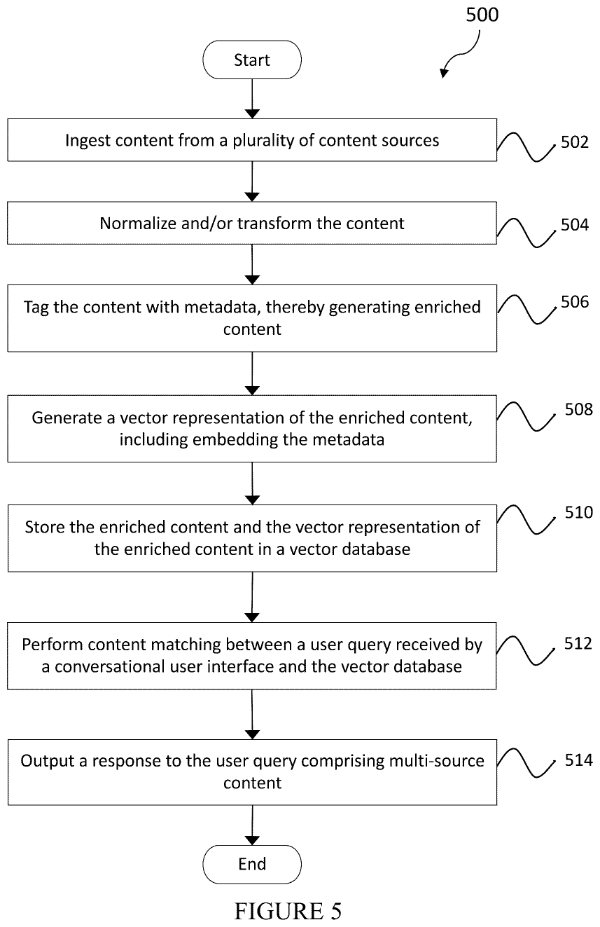

FIG. 5 is a flow diagram illustrating a method for delivering a response comprising multi-source content and contextual affiliate links by a conversational interface to be embedded in a creator network, in accordance with one or more embodiments. Method 500 begins with ingesting content from a plurality of content sources at step 502. The content may be normalized and/or transformed (e.g., using a content ingestion engine as described herein) in step 504. The content may be tagged with metadata at step 506, thereby generating enriched content. A vector representation of the enriched content may be generated at step 508, including embedding the metadata. The enriched content and the vector representation of the enriched content may be stored in a vector database at step 510. Content matching may be performed between a user query received by a conversational user interface and the vector database at step 512, for example by matching the user query against vector representations or document vectors in the vector database. A response to the user query comprising multi-source content may be output at step 514. In some examples, the response may include links and/or documents retrieved from the vector database. In some examples, the response may comprise an auto-generated response. In some examples, the response may comprise a manual response by the content creator.

### Example Computing Systems

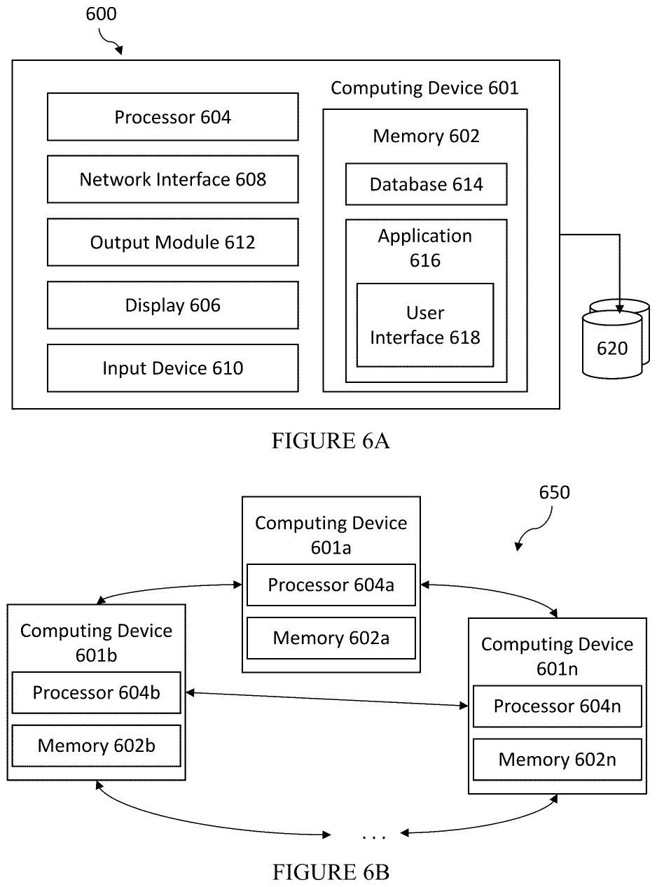

FIG. 6A is a simplified block diagram of an exemplary computing system configured to implement the system shown in FIG. 1 and to perform steps of the method illustrated in FIGS. 2-5, in accordance with one or more embodiments. In one embodiment, computing system 600 may include computing device 601 and storage system 620. Storage system 620 may comprise a plurality of repositories and/or other forms of data storage, and it also may be in communication with computing device 601. In another embodiment, storage system 620, which may comprise a plurality of repositories, may be housed in one or more of computing device 601. In some examples, storage system 620 may store content data, query data, metadata, instructions, programs, and other various types of information as described herein. This information may be retrieved or otherwise accessed by one or more computing devices, such as computing device 601, in order to perform some or all of the features described herein. Storage system 620 may comprise any type of computer storage, such as a hard-drive, memory card, ROM, RAM, DVD, CD-ROM, write-capable, and read-only memories. In addition, storage system 620 may include a distributed storage system where data is stored on a plurality of different storage devices, which may be physically located at the same or different geographic locations (e.g., in a distributed computing system such as system 650 in FIG. 6B). Storage system 620 may be networked to computing device 601 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 601 also may include a memory 602. Memory 602 may comprise a storage system configured to store a database 614 and an application 616. Application 616 may include instructions which, when executed by a processor 604, cause computing device 601 to perform various steps and/or functions, as described herein. Application 616 further includes instructions for generating a user interface 618 (e.g., graphical user interface (GUI)). Database 614 may store various algorithms and/or data, including neural networks, AI models, ingestion engines, data regarding content associated with content creators, content metadata, vector representations, user preferences, among other types of data. Memory 602 may include any non-transitory computer-readable storage medium for storing data and/or software that is executable by processor 604, and/or any other medium which may be used to store information that may be accessed by processor 604 to control the operation of computing device 601.

Computing device 601 may further include a display 606, a network interface 608, an input device 610, and/or an output module 612. Display 606 may be any display device by means of which computing device 601 may output and/or display data. Network interface 608 may be configured to connect to a network using any of the wired and wireless short range communication protocols described above, as well as a cellular data network, a satellite network, free space optical network and/or the Internet. Input device 610 may be a mouse, keyboard, touch screen, voice interface, and/or any or other hand-held controller or device or interface by means of which a user may interact with computing device 601. Output module 612 may be a bus, port, and/or other interface by means of which computing device 601 may connect to and/or output data to other devices and/or peripherals.

In one embodiment, computing device 601 is a data center or other control facility (e.g., configured to run a distributed computing system as described herein), and may communicate with a client device. As described herein, system 600, and particularly computing device 601, may be used for ingesting, normalizing, and transforming content, enrichment features, content matching, generating responses, as described herein. Various configurations of system 600 are envisioned, and various steps and/or functions of the processes described herein may be shared among the various devices of system 600 or may be assigned to specific devices.

FIG. 6B is a simplified block diagram of an exemplary distributed computing system implemented by a plurality of the computing devices, in accordance with one or more embodiments. System 650 may comprise two or more computing devices 601a-n. In some examples, each of 601a-n may comprise one or more of processors 604a-n, respectively, and one or more of memory 602a-n, respectively. Processors 604a-n may function similarly to processor 604 in FIG. 6A, as described above. Memory 602a-n may function similarly to memory 602 in FIG. 6A, as described above.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for delivering multi-source content and contextual affiliate links by a conversational interface comprising:
ingesting content from a plurality of content sources associated with a content creator;
normalizing and/or transforming, by an natural language processing (NLP) layer, the content;
tagging the content with metadata, thereby generating enriched content;
generating a vector representation of the content, including embedding the metadata;
storing the enriched content and the vector representation of the content in a vector database;
performing content matching between a user query received by a conversational user interface against the vector database; and
outputting a response to the user query comprising multi-source content.

2. The method of claim 1, wherein generating the vector representation comprises semantic embedding.

3. The method of claim 1, wherein performing content matching comprises NLP enrichment and performing a hybrid smart vector search.

4. The method of claim 1, wherein performing content matching comprises aligning user query semantics, content response semantics, and affiliate product metadata.

5. The method of claim 1, wherein the content is sourced from a plurality of content sources, including one, or a combination, of a primary content creator website, a linked affiliate page, an affiliate page review, a social media post, a creator-affiliated blog, a creator-affiliated video, a creator-affiliated audio, and a direct message.

6. The method of claim 1, wherein the response further comprises retrieved links.

7. The method of claim 1, wherein the response comprises an auto-generated response.

8. The method of claim 1, wherein the response comprises a manual response from the content creator.

9. The method of claim 1, further comprising determining determine a content depth score for each content source based on relevance, sentiment, and relationship strength with a primary content creator site.

10. A system for delivering multi-source content and contextual affiliate links by a conversational interface comprising:
a memory comprising non-transitory computer-readable storage medium configured to store content and metadata;
a vector database;
one or more processors configured to execute instructions stored on the non-transitory computer-readable storage medium to:
ingest content associated with a content creator;
normalize and/or transform, by a natural language processing layer, the content;
tag the content with metadata, thereby generating enriched content;
generate a vector representation of the content, including embedding the metadata;
store the enriched content and the vector representation of the content in the vector database;
perform content matching between a user query received by a conversational user interface against the vector database; and
output a response to the user query comprising multi-source content.

11. A system for delivering multi-source content and contextual affiliate links by a conversational interface comprising:
a conversational user interface by which a user query may be received and a response to the user query provided;
a content ingestion engine configured to ingest content from a plurality of content sources associated with a content creator;
an NLP layer configured to normalize and transform the content and a user query, such that various processes performed by the system operate on linguistically normalized data;
a metadata tagging module configured to generate enriched content;
an embedding module configured to generate a vector representation of the enriched content;
a vector database storing indexed content, including the enriched content and the vector representation; and
a content matching module configured to match the user query against indexed content from the vector database.

12. The system of claim 11, wherein the content matching module is configured to perform semantic understanding, keyword extraction, and topic matching against the indexed content.

13. The system of claim 11, further comprising a large language model configured to generate a response comprising multi-source content based matches from the indexed content.

14. The system of claim 11, wherein the response further comprises retrieved links.

15. The system of claim 11, wherein the response includes an auto-generated response.

16. The system of claim 11, wherein the response includes a manual response from the content creator.

17. The system of claim 11, wherein the content ingestion engine comprises a direct messages ingestion engine and a comments ingestion engine.
